(19) United States
(12) Patent Application Publication
(10) Pub. No.: US 2003/0117743 A1
(43) Pub. Date: Jun. 26, 2003

(54) Magnetic recording-reproducing apparatus and method for producing magnetic recording-reporducing apparatus

(76) Inventors: Osamu Maeda, Osaka (JP); Masatake Miyamoto, Osaka (JP)

Correspondence Address: ROSENTHAL & OSHA L.L.P., 1221 MCKINNEY AVENUE, SUITE 2800, HOUSTON, TX, 77010, US

(21) Appl. No.: 10/325,569

(22) Filed: Dec. 20, 2002

(30) Foreign Application Priority Data
Dec. 20, 2001 (JP) P2001-387169

(51) Int. Cl. G11B 5/027

(52) U.S. Cl. 360/84

(57) ABSTRACT

A recording-reproducing mechanism in which a cassette storage portion and a cylinder are held and in which an ACE head, a cylinder motor for driving the cylinder to rotate and a loading motor for inserting and ejecting a video cassette are mounted is disposed in a chassis. A main board having a rear end located at a front side with respect to a lead cable draw-out portion of the cylinder is disposed below the recording-reproducing mechanism. The cylinder abuts on the main board and the draw-out portion is located at a side of the main board. The lead cable is drawn out from the rotary transformer and directly connected to a pattern of the main board.

### BACKGROUND OF THE INVENTION

1. Field of the Invention

The present invention relates to a magnetic recording-reproducing apparatus (recording and/or reproducing apparatus) and a method for producing the same. Particularly, it relates to a magnetic recording-reproducing apparatus having a cassette storage portion for storing a video cassette tape, and a cylinder provided with a built-in rotary transformer and adjacently disposed in the rear of the cassette storage portion, and a method for producing the magnetic recording-reproducing apparatus.

2. Description of the Related Art

FIG. 6 is a perspective outside view showing a state in which a recording-reproducing mechanism is mounted on a printed main board in a related-art magnetic recording-reproducing apparatus described in Japanese Utility Model Registration No. 3,079,787. FIG. 7 is a view showing a state in which a lead cable is drawn out from a rotary transformer.

In the magnetic recording-reproducing apparatus, a main board 1 and a recording-reproducing mechanism 2 as shown in FIG. 6 are stored in a housing (not shown). The main board 1 has predetermined circuits printed. Various electric parts are mounted on the main board 1. The recording-reproducing mechanism 2 has a cassette storage portion 3 for storing a video cassette tape, and a chassis 5 having a cylinder holding portion formed for holding a cylinder 4.

The cylinder 4 is provided for recording and/or reproducing a signal on/from the video cassette tape and is adjacently disposed in the rear of the cassette storage portion 3. The cylinder 4 has a built-in rotary transformer 6 as shown in FIG. 7 for taking out a high-frequency signal from a video head. The rotary transformer 6 has a stator side coil 7, and a rotor side coil (not shown) opposite to the stator side coil 7. A lead cable of the stator side coil 7 is connected to a relay board 8 and further connected from the relay board 8 to a connector 10 through a flat cable 9. The connector 10 is inserted into a not-shown connector provided in the main board 1.

The magnetic recording-reproducing apparatus has a tendency to be produced in a smaller size in order to attain reduction in production cost. To attain reduction in cost, it is also necessary to attain both reduction in the number of parts and simplification of production steps.

In the related-art magnetic recording-reproducing apparatus shown in FIG. 7, it is necessary to connect once the lead cable of the stator side coil 7 to the relay board 8, solder one end of the flat cable 9 to the relay board 8, and solder the other end of the flat cable 9 to the connector 10. On the other hand, it is necessary to mount a connector on the main board 1. Hence, the number of production steps increases and the number of parts increases as well.

To attain greater reduction in cost, both simplification of the configuration and reduction in the number of production steps are required.

### SUMMARY OF THE INTENTION

An object of the present invention is to provide a magnetic recording-reproducing apparatus in which the cost can be reduced greatly, and a method for producing the magnetic recording-reproducing apparatus.

According to the invention, there is provided a magnetic recording-reproducing apparatus comprising: a cassette storage portion for storing a video cassette; a cylinder provided with a built-in rotary transformer and adjacently disposed in a rear of the cassette storage portion, the cylinder having a draw-out portion from which a lead cable is drawn out; a housing portion; a recording-reproducing mechanism disposed in the housing portion and holding both the cassette storage portion and the cylinder, the recording-reproducing mechanism mounted with a cylinder motor for driving the cylinder to rotate, and a loading motor for inserting and ejecting the video cassette; and a main board disposed below the recording-reproducing mechanism within the housing portion, the main board having a rear end, wherein the rear end of the main board is located at a front side with respect to the draw-out portion of the cylinder, the cylinder abuts on the main board and the draw-out portion is located at a side of the main board, and the lead cable is drawn out from a rear part of the rotary transformer and directly connected to a pattern of the main board.

According to the invention, there is provided another magnetic recording-reproducing apparatus comprising: a cassette storage portion for storing a cassette; a cylinder provided with a built-in rotary transformer and adjacently disposed in a rear of the cassette storage portion, the cylinder having a draw-out portion from which a lead cable is drawn out; a housing portion; a recording-reproducing mechanism disposed in the housing portion and holding both the cassette storage portion and the cylinder; and a main board disposed below the recording-reproducing mechanism within the housing portion and formed so that the draw-out portion of the cylinder is exposed, wherein the cylinder abuts on the main board and the draw-out portion is located at a side of the main board, and the lead cable is drawn out from a rear part of the rotary transformer and directly connected to a pattern of the main board.

In the related art, the lead cable drawn out from the rotary transformer to an upper side of the recording-reproducing mechanism is connected to the relay board, which is further connected to the connector of the main board through the flat cable. On the other hand, in the invention, the tip portion of the lead cable drawn out from the rotary transformer to the main board side is directly electrically connected to the main board. Hence, the relay board, the flat cable and the connector can be dispensed with. Hence, the number of parts can be reduced to make a large contribution to reduction in cost.

Preferably, the main board has its rear end located at a front side with respect to the lead cable drawn-out portion of the cylinder.

Preferably, a portion of the main board corresponding to the lead cable draw-out portion is cut away.

Preferably, a relay board is connected to a tip of the lead cable and further connected to the main board.

Preferably, a connector is connected to a tip of the lead cable and inserted into a connector of the main board.

When the relay board or connector as described above is used, maintenance can be made easily.

According to the invention, there is provided a method for producing a magnetic recording-reproducing apparatus having a cassette storage portion for storing a cassette, and a cylinder provided with a built-in rotary transformer and adjacently disposed in the rear of the cassette storage portion, the method comprising: disposing the cylinder so that a lead cable is drawn out directly from a surface of a recording-reproducing mechanism on which the rotary transformer is attached to a main board while at least a lead cable draw-out portion of the rotary transformer is exposed out of the main board; and attaching the recording-reproducing mechanism portion to the main board, turning the main board upside down and connecting the lead cable of the rotary transformer directly to the main board.

Because the lead cable of the rotary transformer is directly connected to the main board according to the invention, the related-art step of connecting the relay board, the flat cable or the connector can be dispensed with. Hence, a contribution to reduction in cost can be made according to the invention.

### BRIEF DESCRIPTION OF THE DRAWINGS

FIG. 1 is a view showing the schematic internal configuration of a magnetic recording-reproducing apparatus according to an embodiment of the invention;

FIG. 2 is a view, from a main board side, of the magnetic recording-reproducing apparatus;

FIG. 3 is a view showing a modified example of a main board in the invention;

FIG. 4 is a view showing another example of a method of treating a lead cable of a stator side coil in a rotary transformer;

FIG. 5 is a view showing a further example of the method of treating the lead cable of the stator side coil in the rotary transformer;

FIG. 6 is a perspective outside view showing a state in which a recording-reproducing mechanism is mounted on a printed main board in a related-art magnetic recording-reproducing apparatus; and

FIG. 7 is a view showing a state in which a lead cable is drawn out from the rotary transformer.

### DETAILED DESCRIPTION OF THE PREFERRED EMBODIMENTS

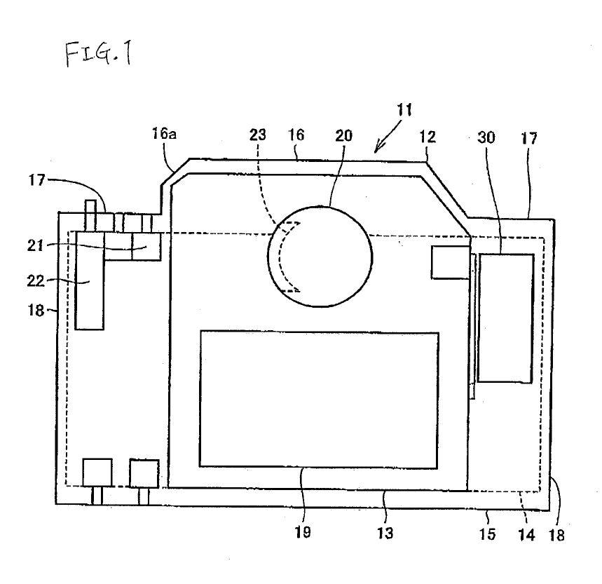

FIG. 1 shows the schematic internal configuration of a magnetic recording-reproducing apparatus according to an embodiment of the invention. FIG. 2 is a view, from a main board side, of the magnetic recording-reproducing apparatus.

In FIG. 1, the magnetic recording-reproducing apparatus 11 has a chassis 12, a recording-reproducing mechanism 13, a main board 14, and an electric part 30. The chassis 12 is a member which is made of a resin and which serves as an outer frame of the recording-reproducing apparatus 11. The chassis 12 is substantially shaped like a rectangular parallelepiped in which a central portion of a rear end portion (upper end portion in FIG. 1) of the chassis 12 is swollen outward. The chassis 12 has a front portion 15, a first back portion 16, second back portions 17, and opposite side portions 18.

In the front portion 15, there are formed a cassette insertion hole (not shown) for inserting and ejecting a video cassette tape, and a plurality of openings (not shown) in which electric parts including a display device and operational parts such as a key switch are disposed.

The first back portion 16 is a portion located at the rearmost end of the recording-reproducing mechanism 13. The first back portion 16 is formed so as to be far from the front portion 15 by a length slight longer than the front-to-rear size of the recording-reproducing mechanism 13. A chamfered portion 16a extending vertically and cut away is formed at a rear end of a left end portion of the first back portion 16. The chamfered portion 16a is cut away enough to prevent an obstacle to the work of connecting cables to I/O jacks 21 and a tuner terminal 22 which will be described later.

The second back portions 17 are portions formed on both sides of the first back portion 16. Each of the second back portions 17 is formed at front side with respect to the first back portion 16. Both the second back portions 17 are formed so as to be far from the front portion 15 by a length slightly larger than the longitudinal length of the main board 14 (in the front to rear direction thereof).

The side portions 18 are side portions between the front portion 15 and the second back portions 17. Both the side portions 18 are formed so as to be far from each other by a length moderately larger than the lateral length of the main board 14 (in the sideward direction thereof).

The recording-reproducing mechanism 13 is a member which is made of a metal and which is disposed in the chassis 12. The recording-reproducing mechanism 13 has a cassette storage portion 19, and a cylinder holding portion 23. A video cassette tape inserted through a cassette insertion hole is disposed in the cassette storage portion 19. The cylinder holding portion 23 is a member for mounting a cylinder 20 in the recording-reproducing mechanism 13. The cylinder holding portion 23 is disposed so as to be adjacent to the cassette storage portion 19. The cylinder 20 is provided for recording/reproduction of a signal on/from the video tape. Other parts such as an ACE head, a cylinder motor for driving the cylinder 20 to rotate, and loading motor for inserting and ejecting a video cassette tape are provided in the recording-reproducing mechanism 13.

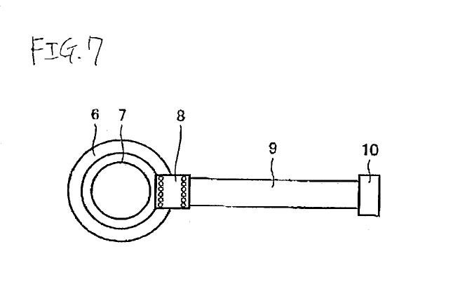

The cylinder 20 has a built-in rotary transformer. In the related art, as shown in FIG. 6, the lead cable is drawn out from the rotary transformer 6 to the upper side of the recording-reproducing mechanism 5 and connected to the relay board 8.

On the other hand, in the invention, as shown in FIG. 2, a lead cable 25 is drawn out from a stator side coil 24 of the rotary transformer to the main board 14 side. A tip portion of the lead cable 25 is directly electrically connected to the main board 14. Hence, the relay board 8, the flat cable 9 and the connector 10 as shown in FIGS. 6 and 7 can be dispensed with. Hence, the number of parts can be reduced and the production steps of connecting these parts can be simplified, so that a great contribution to reduction in cost can be made.

The size of the main board 14 is decided so that the draw-out port of the lead cable 25 is not blocked by the main board 14 when the lead cable 25 is drawn out from the stator side coil 24 to the main board 14 side, and so that the rear end of the main board 14 is located in front of the back side position of the cylinder 20 disposed in the recording-reproducing mechanism 13.

Generally, the main board 14 is obtained by cutting a board having a predetermined size of 1000 mm (longitudinal) by 1000 mm (lateral). If the longitudinal (front-to-rear) size of the main board 14 is 200 mm, five pieces of main boards 14 can be produced. If the longitudinal size of the main board 14 is 166 mm, six pieces of main boards 14 can be produced. Hence, greater reduction in cost can be attained if a board having a longitudinal size of 166 mm is used as the main board 14. If the longitudinal size of the main board 14 is selected thus, the area of parts allowed to be mounted on the main board 14 is narrowed but the problem of reduction of the area can be solved by use of small-sized parts or a highly integrated semiconductor device.

For production of the magnetic recording-reproducing apparatus 11 according to the invention, the electric part 30 or the like is mounted on the main board 14 and soldered in a dip tank in advance. In the recording-reproducing mechanism 13, the cylinder 20 is held by the cylinder holding portion 23 so that the lead cable draw-out port faces the main board side in advance. In the condition that the recording-reproducing mechanism 13 is disposed so that the lead cable draw-out port faces upward, the main board 14 turned upside down is mounted on the recording-reproducing mechanism 13 and the lead cable 25 is soldered to patterns of the main board 14 as shown in FIG. 2.

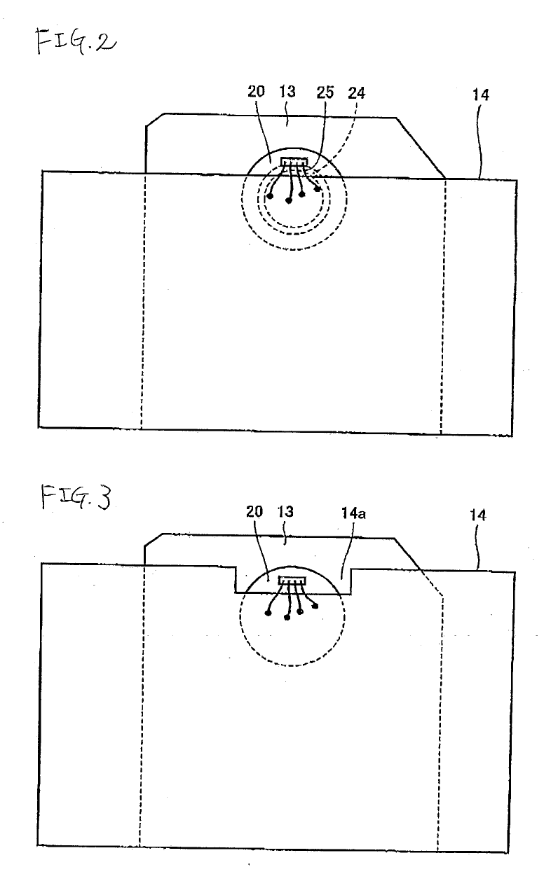

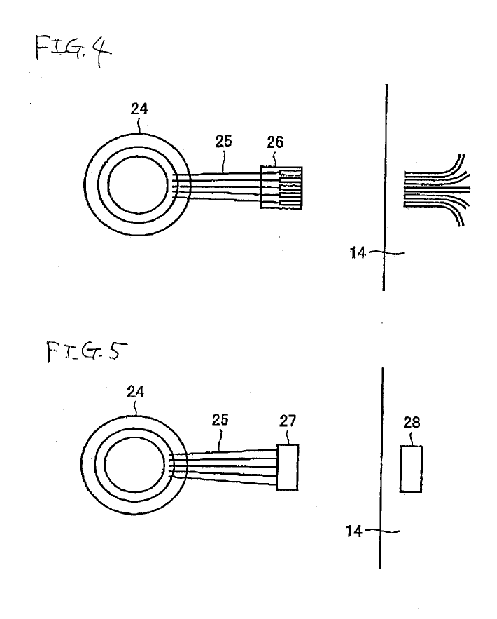

FIG. 3 is a view showing a modified example of the main board in the invention. In the example shown in FIG. 2, the area of parts allowed to be mounted on the main board 14 is narrowed. When a main board larger in the area of parts than that of the main board 14 shown in FIG. 2 is required, the longitudinal length of the main board 14 may be elongated and a notch 14a may be formed so that the draw-out port of the lead cable 25 from the rotary transformer is not blocked by the main board 14, as shown in FIG. 3.

Alternatively, an opening may be formed in place of the notch 14a in a portion of the main board 14 corresponding to the lead cable draw-out port.

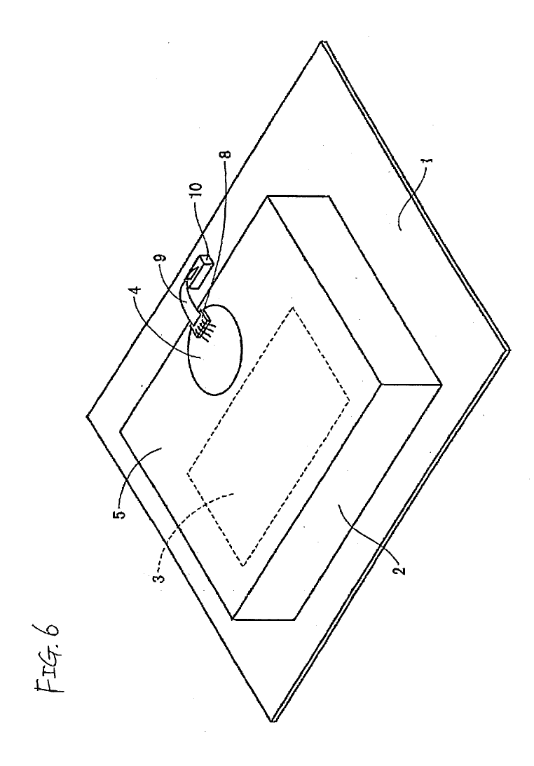

FIGS. 4 and 5 show other embodiments of methods of treating the lead cable of the stator side coil in the rotary transformer. Although the embodiment shown in FIG. 2 is configured so that the lead cable 25 in the rotary transformer is directly connected to the main board 14, the embodiment shown in FIG. 4 is configured so that the lead cable 25 is connected to a relay board 26 which is connected to the main board 14.

On the other hand, the embodiment shown in FIG. 5 is configured so that the lead cable 25 is connected to a connector 27 which is inserted in a connector 28 provided on the main board side.

These embodiments have an advantage that maintenance can be made easily compared with the embodiment shown in FIG. 2.

It is to be understood that the embodiments disclosed in the description are for the purpose of illustration but not for the purpose of limitation in all respects. The scope of the invention is not intended to be limited to the described embodiments but is intended to contain the scope of claims and various changes equivalent to the scope of claims and within the scope of claims in terms of meaning.

As described above, in accordance with the invention, the main board which is formed so that the lead cable draw-out port of the cylinder is exposed is disposed below the recording-reproducing mechanism and a lead cable is drawn out from a surface side of the rotary transformer of the cylinder abutting on the main board and is directly connected to the pattern surface of the main board. Hence, parts such as a flat cable can be dispensed with, so that the number of parts can be reduced. Moreover, the step of connecting the flat cable or the like can be dispensed with, so that the number of production steps can be reduced. Accordingly, a great contribution to reduction in cost can be made.

What is claimed is:

1. A magnetic recording-reproducing apparatus comprising;
a cassette storage portion for storing a video cassette;
a cylinder provided with a built-in rotary transformer and adjacently disposed in a rear of the cassette storage portion, the cylinder having a draw-out portion from which a lead cable is drawn out;
a housing portion;
a recording-reproducing mechanism disposed in the housing portion and holding both the cassette storage portion and the cylinder, the recording-reproducing mechanism mounted with a cylinder motor for driving the cylinder to rotate, and a loading motor for inserting and ejecting the video cassette; and
a main board disposed below the recording-reproducing mechanism within the housing portion, the main board having a rear end,
wherein the rear end of the main board is located at a front side with respect to the draw-out portion of the cylinder,
the cylinder abuts on the main board and the draw-out portion is located at a side of the main board, and
the lead cable is drawn out from a rear part of the rotary transformer and directly connected to a pattern of the main board.

2. A magnetic recording-reproducing apparatus comprising:
a cassette storage portion for storing a cassette;
a cylinder provided with a built-in rotary transformer and adjacently disposed in a rear of the cassette storage portion, the cylinder having a draw-out portion from which a lead cable is drawn out;
a housing portion;
a recording-reproducing mechanism disposed in the housing portion and holding both the cassette storage portion and the cylinder; and
a main board disposed below the recording-reproducing mechanism within the housing portion and formed so that the draw-out portion of the cylinder is exposed,
wherein the cylinder abuts on the main board and the draw-out portion is located at a side of the main board, and
the lead cable is drawn out from a rear part of the rotary transformer and directly connected to a pattern of the main board.

3. A magnetic recording-reproducing apparatus according to claim 2, wherein the main board has a rear end located at a front side with respect to the draw-out portion.

4. A magnetic recording-reproducing apparatus according to claim 2, wherein a portion of the main board corresponding to the draw-out portion is cut away.

5. A magnetic recording-reproducing apparatus according to claim 2, wherein a relay board is connected to a tip of the lead cable and connected to the main board.

6. A magnetic recording-reproducing apparatus according to claim 2, wherein a connector is connected to a tip of the lead cable and inserted into a connector of the main board.

7. A method for producing a magnetic recording-reproducing apparatus having a cassette storage portion for storing a cassette, and a cylinder provided with a built-in rotary transformer and adjacently disposed in the rear of the cassette storage portion, the method comprising:
disposing the cylinder so that a lead cable is drawn out directly from a surface of a recording-reproducing mechanism on which the rotary transformer is attached to a main board while at least a lead cable draw-out portion of the rotary transformer is exposed out of the main board; and
attaching the recording-reproducing mechanism portion to the main board, turning the main board upside down and connecting the lead cable of the rotary transformer directly to the main board.
